(19) United States
(12) Patent Application Publication
(10) Pub. No.: US 2007/0003736 A1
(43) Pub. Date: Jan. 4, 2007

(54) Method and device for producing a multi-ply web of flexible material, such as paper and nonwoven, and multi-ply material produced by the method

(75) Inventors: Eva-Li Saarvali, Vastra Frolunda (SE); Anders Andersson, Stenungsund (SE)

Correspondence Address: YOUNG & THOMPSON, 745 SOUTH 23RD STREET, 2ND FLOOR, ARLINGTON, VA, 22202, US

(73) Assignee: SCA HYGIENE PRODUCTS AB, GOTEBORG (SE)

(21) Appl. No.: 11/515,892

(22) Filed: Sep. 6, 2006

Related U.S. Application Data
(63) Continuation-in-part of application No. PCT/SE04/00393, filed on Mar. 18, 2004.

(51) Int. Cl. B32B 3/10; B32B 37/00

(52) U.S. Cl. 428/137; 428/138; 156/253; 156/291

(57) ABSTRACT

Method for producing a multi-ply web (19) of flexible material, such as paper and nonwoven material, including at least one first (1) and one second ply (8) which are interconnected by gluing in a glue pattern (12;24). The multi-ply web is produced by applying glue in a glue pattern to a first web shaped material (1) from a patterned glue transfer roll (5), laminating a second web shaped material (8) with the first web shaped material (1) in a press nip between a lamination roll (10) and an impression roll (7). After lamination the laminated web (19) is cut and/or perforated (22;25) in register with the glue transfer and lamination while still residing on the impression roll (7). There is also provided a multi-ply web which is cut or perforated in a pattern (22;25) which is in register with the glue pattern (12;24).

### FIELD OF THE INVENTION

The present invention refers to a method for producing a multi-ply web of flexible material, such as paper and nonwoven material, by means of gluing the plies. Especially it refers to production of tissue products such as toilet and kitchen paper, paper towels, hand towels, napkins, handkerchiefs, wiping material and the like. The invention further refers to a multi-ply web of flexible material, such as paper and nonwoven, comprising at least a first and a second ply, which are interconnected by means of gluing in a glue pattern.

### BACKGROUND OF THE INVENTION

It is very common to laminate two or more tissue plies in order to produce the final tissue product. Herewith a more flexible and softer tissue product is obtained as compared to if one single ply with a corresponding thickness and basis weight had been produced as for the laminated product. The absorbent capacity and the bulk are moreover improved.

The lamination of two or more tissue plies is often made by means of gluing. A mechanical embossing of the plies is also often performed before they are glued together. It is further known to laminate two plies only by means of a mechanical embossing, at which a mechanical joining of the plies occurs in the embossing sites.

Through for example EP-A-796 727 it is known to first emboss two paper plies in a three dimensional structure with alternating raised and recessed portions, after which glue is applied to one of the plies and the two plies are joined in a press nip between two embossing rolls, so that the raised portions of the respective plies are glued to each other. A similar embossing procedure is shown in EP-A-738 588, according to which the glue also has a colouring effect.

In WO 95/08671 there is enclosed an example of so called nested embossing, in which the two individually embossed plies are combined and joined with the raised portions of one ply nesting into the recessed portions of the opposite ply.

Through U.S. Pat. No. 5,443,889 there is known a procedure for laminating two paper plies, which are fed over a pattern roll each, said pattern rolls having alternating raised and recessed portions and where glue is applied to one ply while this is led over the roll. The two paper plies are then glued together in a nip between the two pattern rolls, which are in register with each other so that a joining and compression of the paper plies occurs in a pattern corresponding to the raised portions of the pattern rolls.

A drawback that occurs in connection with embossing a paper web where this is compressed in spots, is that a considerable strength reduction occurs in the embossing sites, which effects the strength properties of the entire paper product. Strength reductions of up to 70% of an embossed paper as compared to a corresponding unembossed paper are not unusual.

In WO 03/072344 there is disclosed a method for producing a multi-ply paper or nonwoven material, by means of gluing the plies wherein a glue transfer roll and a lamination roll are driven in register. The glue transfer roll and the lamination roll have corresponding patterns of protuberances so that the plies are glued together in a pattern corresponding to the configuration of the protuberances.

Printing of tissue paper with a colorant is often made for aesthetical reasons. The printing pattern could be any pattern including more or less continuous lines, line segments, dots, trademarks, logotypes, symbols, fantasy characters etc. In a multiply web material printing is usually made on the outside of the multiply web, but may also be on the inner side of one ply, wherein it is visible through the ply.

In Swedish patent application no. 0203847-9 there is disclosed a method for producing a multiply paper or nonwoven, wherein at least one of the plies is printed in register with gluing and laminating two or more plies together to form a printed multiply web material.

In Swedish patent application no. 0301168-1 there is disclosed a method for producing a laminated, embossed and printed multiply paper or nonwoven, wherein embossing, printing and lamination are synchronized, so that printing mainly occurs on the non-embossed areas of the web.

Web materials, such as tissue paper and nonwoven, are often perforated or cut at predetermined intervals in the converting process, to produce sheets of a desired size. This cutting or perforation is applied independently of other treatment processes, such as printing, embossing and lamination and will therefore appear randomly in relation to these other processes on the finished product. Due to the random perforation and cutting it often happens that decorated areas in a product will be broken by the perforations or cuts. This means that for example printed text, edge decorations, frames and/or decorative pattern will be broken.

### OBJECT AND SUMMARY OF THE INVENTION

The object of the present invention is to provide a method for producing a multi-ply web of flexible material, such as paper and nonwoven material, wherein at least two plies of flexible material are laminated together by gluing in a glue pattern. The multi-ply web is perforated or cut eliminating the problem referred to above of a perforation or cutting which is random with respect to for example glue patterns, printed patterns, embossing patterns or the like.

This has according to the invention been provided by applying glue in a glue pattern to a first web shaped material from a patterned glue transfer roll, laminating a second web shaped material with the first web shaped material in a press nip between a lamination roll and an impression roll, and wherein after lamination the laminated web is cut and/or perforated in register with the glue transfer and lamination while still residing on said impression roll or directly in connection with said impression roll.

According to one aspect of the invention the laminated web is cut and/or perforated so as to divide said laminated web into a plurality of web sections

In one embodiment the first web shaped material and/or the second web shaped material is printed by a printing roll carrying a colorant, a surfactant, a skin care agent or other functional chemical in a selected pattern, said printing is performed in register with the glue transfer while the first and/or second web shaped materials are residing on said impression roll.

Preferably the laminated web is cut and/or perforated in register with the printing so that the printed pattern is undisrupted by the cuts and/or perforations.

In a further embodiment glue is transferred to said first web shaped material in a pattern corresponding to the contours of an object and that after lamination with said second web shaped material the laminated web is cut and/or perforated adjacent or immediately outside said glue pattern, so as to form objects of laminated web of a desired shape.

In one aspect of the invention the glue pattern does not extend around the entire circumference of the object, but leaves at least one opening through which the interior space between the first and second web shaped materials is accessible. Preferably said object is free from glue sites inside said glue pattern located along the contours of the object. According to one embodiment the object is a mitten, glove or pouch.

In one embodiment the cutting and/or perforation of the laminated web is synchronized with the printing of a printed pattern and/or the application of a coloured glue pattern in such a way that web sections have substantially the same pattern printed on them.

According to a further embodiment the cutting or perforation is carried out by a device having at certain intervals cutting or perforating members and that the impression roll, or a separate counter roll arranged in direct connection with the impression roll and driven in register therewith, at certain intervals is provided with hardened steel bars or anvil knives cooperating with said cutting or perforating members, wherein the cutting or perforation device is synchronized with the impression roll or the counter roll so that said cutting or perforating members are brought into contact with the hardened steel bars or anvil knives when they hit the impression roll or the counter roll.

According to one aspect of the invention least one of the plies before lamination with the opposite ply is exerted to a three dimensional patterning, which has been provided on the ply while wet, during drying of the wet ply and/or in dry state.

According to a further aspect of the invention at least one ply is embossed in a selected embossing pattern in register with the lamination and perforation and/or cutting of the web material.

According to a further embodiment any of said web shaped materials comprises one or more plies of flexible material.

The invention further refers to a multi-ply web of flexible material, such a paper and nonwoven, comprising at least one first and one second ply which are interconnected by gluing in a glue pattern and wherein the web is cut or perforated in a pattern which is in register with the glue pattern.

According to one embodiment the multi-ply web is printed with at least one printing pattern comprised of a colorant, a surfactant, a skin care agent or other functional chemical, said printing pattern is in register with the glue pattern and the pattern of cuts or perforations.

The lamination roll may in one embodiment have a pattern of protuberances corresponding to the glue pattern, the glue transfer roll and the lamination roll being in register with each other.

According to a further embodiment the glue is coloured and thus appears as a printed pattern which is visible from the outer side of the multi-ply web.

In one aspect of the invention the glue pattern corresponds to the contours of an object and the laminated web is cut or perforated adjacent or immediately outside said glue pattern, so as to form objects of laminated web of a desired shape.

In one aspect of the invention the glue pattern does not extend around the entire circumference of the object, but leaves at least one opening through which the interior space between the first and second web shaped materials is accessible. Preferably said object is free from glue sites inside said glue pattern located along the contours of the object. According to one embodiment the object is a mitten, glove or pouch.

The multi-ply web may further have any of the features provided by any of the method steps referred to above.

Further features of the invention are disclosed in the following description and in the claims.

### BRIEF DESCRIPTION OF THE DRAWINGS

The invention will in the following be closer described with reference to some embodiments shown in the accompanying drawings.

FIG. 1 shows a schematic side view of a embodiment of a device for performing the method according to the invention.

FIG. 2 shows a schematic side view of another embodiment of the device according to the invention.

FIG. 3 is a plan view of one embodiment of a multiply web according to the invention.

FIG. 4 is a plan view of a further embodiment of a multiply web according to the invention.

### DEFINITIONS

The terms tissue paper and nonwoven materials as used herein are defined as follows:

Tissue Paper

A tissue paper is defined as a soft absorbent paper having a basis weight below 65 g/m² and typically between 10 and 50 g/m². Its density is typically below 0.60 g/cm³, preferably below 0.30 g/cm³ and more preferably between 0.08 and 0.20 g/cm³. Moist tissue paper webs are usually dried against one or more heated rolls. A method which is commonly used for tissue paper is so called yankee drying. At yankee drying the moist paper web is pressed against a steam-heated yankee cylinder, which can have a very large diameter. The paper web is usually creped against the yankee cylinder.

Another drying method is so called through-air-drying (TAD). In this method the paper is dried by means of hot air blown through the moist paper web, often without a preceding wet pressing. In connection with the TAD drying the patterned structure of the drying fabric is transferred to the paper web. This structure is essentially maintained also in wet condition of the paper, since it has been imparted to the wet paper web.

In the international patent application no. PCT/SE98/02461 there is disclosed a method for producing an impulse dried paper, especially tissue paper, having a three-dimensional pattern, said paper having high bulk and softness. Impulse drying shortly involves that the moist paper web is passed through the press nip between a press roll or press shoe and a heated roll, which is heated to such a high temperature that a quick and strong steam generation occurs in the interface between the moist paper web and the heated roll. The three-dimensional embossment pattern is accomplished by means of a pattern provided on the heated roll. The counter means, for example a press felt, against which the paper is pressed in connection with the simultaneous impulse drying and shaping, has a non-rigid surface.

The present invention refers to all types of tissue paper. The tissue paper may be creped or non-creped. The creping may take place in wet or dry condition. It may further be foreshortened by any other methods, such as so called rush transfer between wires.

The fibers contained in the tissue paper are mainly pulp fibers from chemical pulp, mechanical pulp, thermo mechanical pulp, chemo mechanical pulp and/or chemo thermo mechanical pulp (CTMP). The fibers may also be recycled fibers. The tissue paper may also contain other types of fibers enhancing e.g. strength, absorption or softness of the paper. These fibers may be made from regenerated cellulose or synthetic material such as polyolefins, polyesters, polyamides etc.

The tissue paper coming out from the tissue paper machine may comprise one or more layers. In the case of more than one layer this is accomplished either in a multi-layered headbox, by forming a new layer on top of an already formed layer or by couching together already formed layers. These layers can not or only with considerable difficulty be separated from each other and are joined mainly by hydrogen bonds. The different layers may be identical or may have different properties regarding for example fibre composition and chemical composition.

A tissue paper is defined as a soft absorbent paper having a basis weight below 65 g/m² and typically between 10 and 50 g/m². Its density is typically below 0.60 g/cm³, preferably below 0.30 g/cm³ and more preferably between 0.08 and 0.20 g/cm³. The tissue paper may be creped or non-creped. The creping may take place in wet or dry condition. It may further be foreshortened by any other methods, such as so called rush transfer between wires.

The fibers contained in the tissue paper are mainly pulp fibers from chemical pulp, mechanical pulp, thermo mechanical pulp, chemo mechanical pulp and/or chemo thermo mechanical pulp (CTMP). The fibers may also be recycled fibers. The tissue paper may also contain other types of fibers enhancing e.g. strength, absorption or softness of the paper. These fibers may be made from regenerated cellulose or synthetic material such as polyolefins, polyesters, polyamides etc.

Nonwovens

The term nonwoven is applied to a wide range of products which in term of their properties are located between the groups of paper and cardboard on the one hand and textiles on the other hand. As regards nonwoven a large number of extremely varied production processes are used, such as the air-laid, wetlaid, spunlaced, spunbond, meltblown techniques etc. Nonwovens represent flexible porous fabrics that are not produced by the classical methods of weaving or knitting, but by intertwining and/or by cohesive and/or adhesive bonding of typical synthetic textile fibers, which may for example be present in the form of endless fibers or fibers prefabricated with an endless length, as synthetic fibers produced in situ or in the form of staple fibers. Alternatively they may be made from natural fibers or from blends of synthetic fibers and natural fibers.

Ply

A paper comes out from the paper machine as a single-ply paper sheet, which later in the converting process can be combined with other plies by a lamination process, such as gluing and or embossing, to form a multi-ply material. The same applies to a nonwoven material. A single ply may comprise one, two or more layers, for example obtained by using a multi-layered headbox, by forming the web layers on top of each other in a sequential mode, or by forming each layer in a separate forming unit before couching the layers together in the paper machine while still in a wet condition.

Web Shaped Material

The term web or web shaped material as used herein refers to a flexible sheet of material, paper or nonwoven, which is fed and treated, for example glued, printed, embossed etc. in a machine equipment as one single sheet and may comprise a single ply or two or more plies which are combined.

Register

The term “in register with” as used herein refers to that different parts of the device are controlled so as to be driven in exact correspondence with each other.

### DETAILED DESCRIPTION OF THE INVENTION

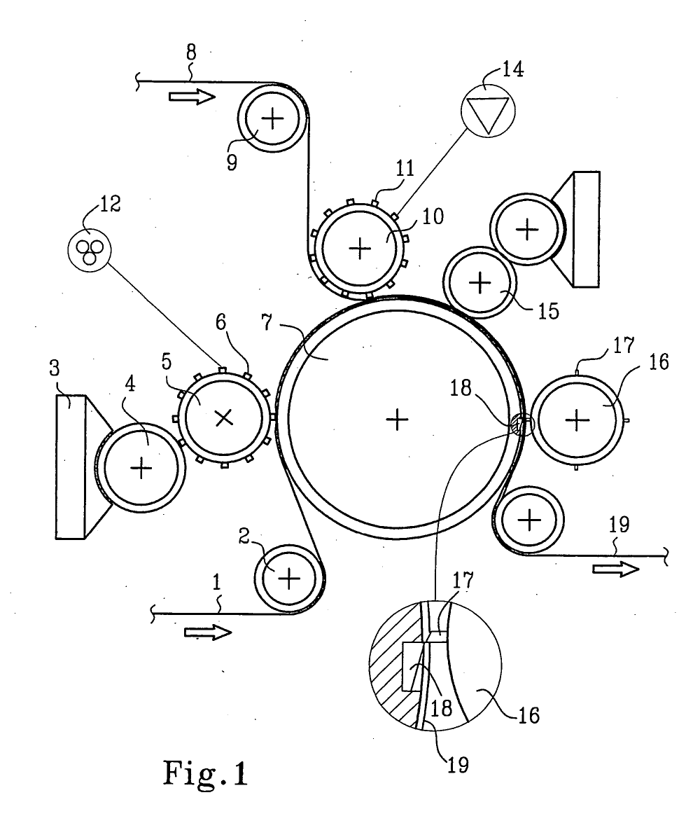

FIG. 1 shows a device for producing a two-ply material, of e.g. paper, especially tissue paper, or nonwoven material. The material will hereinafter be referred to as “paper”. A first paper web 1 is fed over a roll 2 and an impression roll 7. While residing on the impression roll 7 the first paper web 1 is fed towards a glue application station. This comprises a glue chamber 3 from which glue is applied on a glue roll 4. The glue roll 4 is in contact with a first patterned glue transfer roll 5, which along its periphery is provided with a pattern of protuberances 6. The glue roll 4 is only contacting the tops of the protuberances 6, so that glue is applied only thereon. The paper web 1 is passed into a press nip between the glue transfer roll 5 and the centrally placed impression roll 7. Glue will thus be applied to the first paper web 1 in a pattern corresponding to the configuration of the tops of the protuberances 6.

The pressure in the press nip between the glue transfer roll 5 and the impression roll 9 is low and only sufficiently high to accomplish a transfer of glue to the paper web 1. According to one aspect of the invention no or only a slight deformation of the paper web takes place, i.e. no distinct impression of the protuberances 6 of the glue transfer roll 5 into the paper web will occur. A certain deformation may however occur due to the wetting effect from the glue.

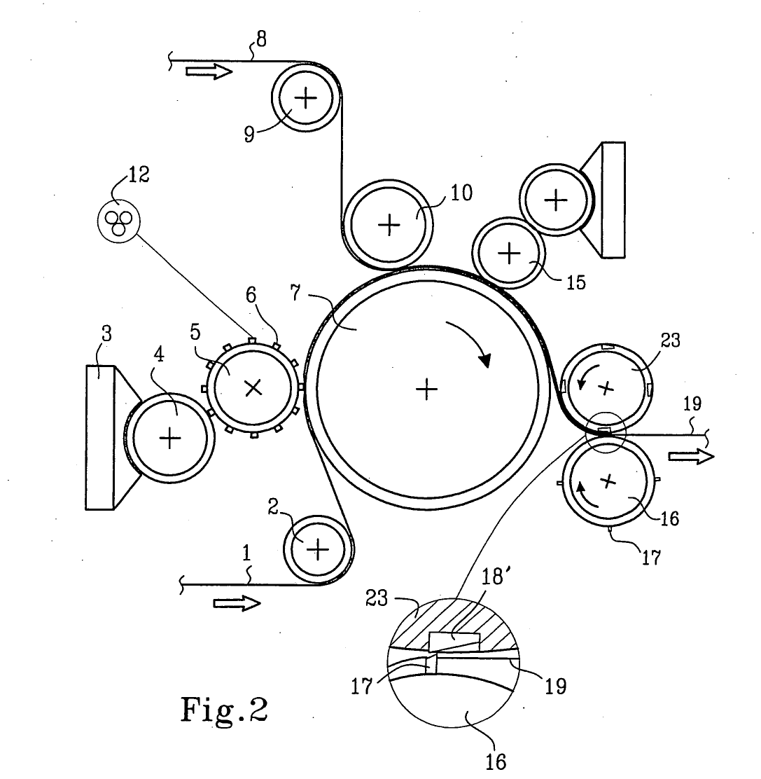

A second paper web 8 is fed over a roll 9 and into a press nip between a lamination roll 10 and the centrally placed impression roll 7. The lamination roll 10 has a three dimensional pattern of protuberances 11 corresponding to the pattern of the protuberances 6 on the glue transfer roll 5. The term “corresponding to” in this respect means that the protuberances 11 either have the same shape and size of the effective surface area as the protuberances 6 of the glue transfer roll 5, the same shape but a larger effective surface area than the protuberances 6 of the glue transfer roll 5 so as to extend outside the outer circumference of the glue sites provided by the glue transfer roll 5, the same shape but a smaller effective area than the protuberances 6 of the glue transfer roll 5 or a different shape and a larger effective surface area than the protuberances 6 of the glue transfer roll 5. For example a glue pattern 13 provided by the first pattern roll 5 may be in the form of groups of three dots provided by protuberances 6 having the configuration 12 as shown in FIG. 2, wherein 12 is a partial plan view in an enlarged scale, wherein the protuberances 11 of the lamination roll 10 may have be exactly the same shape or be slightly larger or smaller than the glue pattern, or may for example have the configuration of a triangle 14 (shown in the form of a partial plan view in an enlarged scale in FIG. 2) covering the three dots. In all these cases the relative positions of the patterns on the glue transfer roll 5 and the lamination roll 10 are in correspondence with each other.

The glue transfer rolls 5 and the lamination roll 10 are driven in register with each other so that the first and second paper webs 1 and 8 are pressed and glued together in a pattern corresponding to the configuration of the glue pattern provided by the glue transfer roll 5.

In the case of large glue sites 13 screened patterns can be used, which means that each glue pattern unit is built up of a plurality of small screen dots. The size of the glue site in this case is defined as the circumscribed area of the combination of screen dots forming a glue pattern unit.

It is preferred that one central impression roll 7 is used for both the glue transfer roll 5 and the lamination roll 10, as is shown in FIG. 1. However it would of course also be possible to use two separate impression rolls and to synchronize them so that they are driven in register.

Also in this second press nip the pressure should be sufficiently high to provide a gluing together of the two paper webs 1 and 8. The pressure in the second press nip should preferably not be higher than to cause only slight compacting impressions just opposite the glue sites in the second ply 8 facing the lamination roll 10.

The opposite external surface of said multi-ply web, i e the surface facing the central impression roll 7 will substantially maintain its structure unaffected by the lamination process with no compacting impressions in the material opposite the glue sites. A slight deformation may however occur due to the wetting effect by the glue.

Preferred glues are the ones commonly used for paper, such as carboxy methyl cellulose (CMC), polyvinyl alcohol (PVOH), ethylene vinyl acetate (EVA), polyvinyl acetate (PVAc), ethylene acrylic acid, vinyl acetate acrylic acid, styrene acrylic acid, polyurethane, polyvinylidene chloride, starch, chemically modified starch, dextrin, water soluble polymers such as latexes and milky colloids in which natural or synthetic rubber or plastic is suspended in water. In case the material webs are of other material than paper glues suited for these materials are of course chosen.

It is preferred that glues having a relatively high dry content are used, since this enables a distinct positioning of the glue sites.

Coloured glues may also be used, which give a visual effect and therewith a patterning effect to the material.

A printing roll 15 can be arranged after the lamination roll 10 for printing on the outside of the second web shaped material 8. This printing unit may be a flexographic printing device or any optional printing device adapted to print a colorant, a surfactant, a skin care agent or other functional chemical on paper or nonwoven. The second web shaped flexible material 8 is printed while residing on the central impression roll 7 and the printing roll 15 is driven in register with the glue transfer roll 5 and the lamination roll 10. The printing pattern is printed on the outside of the second web shaped material 8 and is in register with the glue pattern. The term “in register with” generally refers to that two or more patterns are applied with fixed relationship to each other, and are either overlapping or non-overlapping. The term “overlapping” includes that the patterns are located just above each other or are only partly covering each other.

The printing pattern provided by the printing roll 15 will appear on the outside of the laminated multiply product. It may alternatively or additionally be possible to print a printing pattern on the first web shaped flexible material 1 before lamination. This printing pattern will then appear on the inside of the laminated multiply product and be visible through the plies, in case the printing pattern is a coloured pattern.

In case the printing pattern is a surfactant, a skin care agent or other functional chemical it may be of advantage to have the chemical substance on the inside of the laminated product, so that it is protected during the converting process and before use and becomes active only after wetting of the paper. However for some applications it may be advantageous to have the active substance on the outside of the laminated product, so that it is active also without wetting the product.

In further embodiments two or more printing rolls may be provided, which print two or more patterns in subsequent steps on said first web shaped flexible material 1 before it is laminated to the second web shaped flexible material 8. Said patterns are printed in register with each other. In still further embodiments two or more printing rolls may be provided, which print in subsequent steps on said second web shaped flexible material 8 after lamination to the first web shaped flexible material 1, said patterns being printed in register with each other. The lamination roll 10 may further act as a printing roll carrying a colorant, a skin care agent or other functional chemical in a selected pattern, which is printed on the outside of the laminated product.

In still further embodiments no printed pattern or coloured glue pattern is applied on any of the web shaped materials nor on the laminated multiply web.

After printing the laminated multiply web is perforated or cut by means of an optional perforating or cutting roll 16. The impression roll may at certain intervals be provided with hardened steel bars or hardened anvil knives 18 or the like intended to cooperate with the cutting or perforating members 17 of the perforating or cutting roll 16. Thus the intervals between said hardened steel bars or anvil knives 18 should correspond to the distance between said cutting or perforating members 17 so that they will be brought into contact with the hardened steel bars or anvil knives 18 when they hit the impression roll 7. The perforating members 17 may be arranged in a helical fashion.

FIG. 2 shows another embodiment, which differs from the one shown in FIG. 1 by the fact that the lamination roll 10 has smooth surface and thus no three dimensional pattern of protuberances. Further the perforating or cutting roll 16 does not cooperate with the central impression roll 7, as in the embodiment shown in FIG. 1, but with a counter roll 23 arranged in direct connection with the impression roll 7 and driven in register therewith. The counter roll 23 is provided with hardened anvil knives 18′ in a corresponding manner as described above with respect to the impression roll of FIG. 1.

The different components from the different embodiments may of course be combined with each other in any optional way.

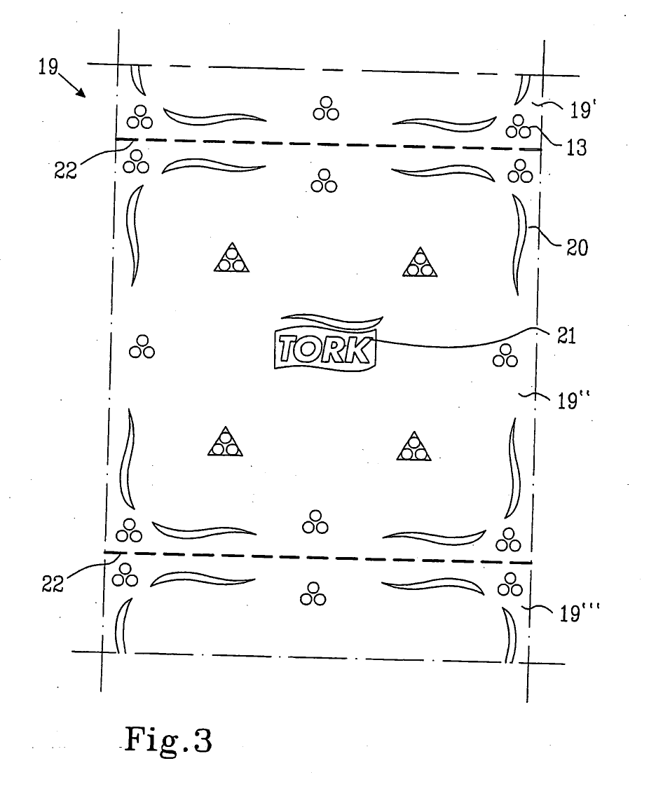

FIG. 3 shows an example of a multiply web 19 made with a device according to the device shown in FIG. 1. The glue pattern 12 is in the form of groups of three dots 13 arranged in a triangular configuration. The glue pattern may be coloured or colourless, so that it either does or does not form part of the patterning effect of the multiply web. A first printed pattern 20 in the form of a figurative pattern and a second printed pattern 21 in the form of a logotype are printed on the web. The patterns 10 and 21 may be printed on the outside of the web or on the inside thereof, so that they are visible through the plies. One pattern may also be printed on the inside and the other on the outside of the web as is discussed above.

Perforations 22 are provided which divide the web 19 into web sections 19′, 19″ and 19′″. The perforations 22 are synchronized with the printed patterns 20 and 21, so that the printed patterns are undisrupted by the perforations 22 and preferably so that the web sections 19′,19″ and 19′″ have substantially the same printed patterns on them. In case the glue is a coloured glue which provides a visible glue pattern, the same applies to the glue pattern.

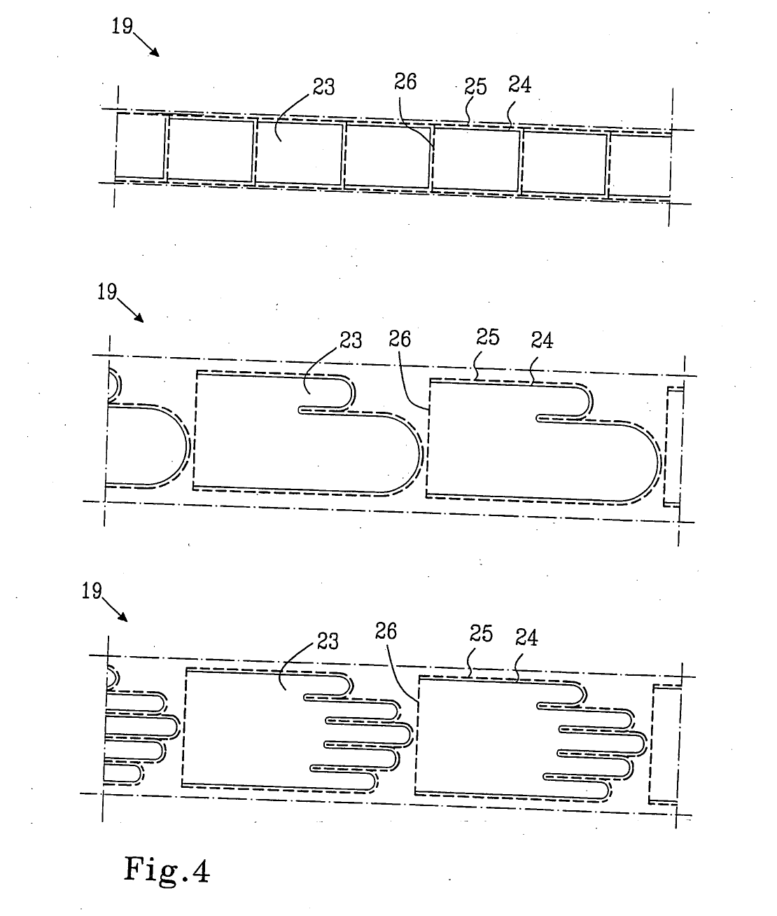

In FIG. 4 is shown some embodiments in which the cuts or perforations 25 define the contours of an object 23, in the present case a pouch, a mitten and a glove respectively. The glue pattern 24 in this case corresponds to the contours of said object 23. The glue pattern 24 may either be in the form of continuous lines or be discontinuous in the form of dots or short lines configured according to the contours of the object. The cuts or perforations 25 are located adjacent, on or immediately outside the glue pattern 24. The pouch, mitten or glove 23 is intended to be used for wiping or washing purposes.

The present invention in which cutting or perforation is performed in register with glue lamination thus provides the possibility to produce laminated products of complicated shape, wherein the glue pattern follows the contours of the product. In the example of a pouch, a glove or mitten, the glue pattern 24 does not extend around the entire circumference of the object, but leaves an opening 26 through which the interior space between the first and second web shaped materials is accessible. Preferably there are no glue sites inside said the glue pattern 24 located along the contours of the object 23.

In case cutting lines 25 are provided along the periphery of the object 23, such cutting lines should not be continuous but leave sufficient tab bonds between cuts, so that the multi-ply web can be handled in the machine equipment until it reaches a station where the objects 23 are completely separated from the web. The objects may alternatively be delivered in the form of a continuous web, and be separated by the customer.

A two-sided product may be desirable in cases where the opposite sides of the product should have different properties, for example one soft, smooth and absorbent side and one side for example having a more rough surface adapted for cleaning and/or a surface having a three-dimensional structure suited for wiping viscous fluids.

The paper webs 1 and 8 that are laminated can be either smooth but also have a three-dimensional structure provided earlier in the process, for example during forming, dewatering and/or drying of the paper web. A three-dimensional structure may also be provided by embossing the dry paper webs before lamination. The method according to the invention is very lenient to such a pattern, so that this is maintained substantially intact throughout the laminating process. The paper webs 1 and 8 laminated together may be of the same or different type. For example, as explained above, a two-sided product may be provided where different sides of the multiply product have different properties.

In still a further embodiment at least one ply is embossed in a selected embossing pattern in register with the lamination and perforation and/or cutting of the web material. Synchronization of embossing, glue lamination and printing is disclosed in Swedish patent application no. 0301168-1, wherein embossing and printing operations are synchronized so that printing mainly occurs in non-embossed areas of the web. In a corresponding manner the web, by keeping the perforation or cutting in register with the other operations, may be cut or perforated in non-embossed and non-printed areas of the web.

The laminated multiply product may also if desired be embossed after the lamination process and after leaving the impression roll.

Three or more paper or nonwoven plies may of course be laminated with the method described above. Two or more glue stations may therefore be provided, which are driven in register and/or two or more plies may enter the first and/or further press nips.

Different kind of paper or nonwoven with different properties with respect to absorption capacity, basis weight, manufacturing technique, fiber composition, chemical additives may be used in the different plies.

The method is further suitable to use for paper plies having holes therein, since the main part of the holes will be intact throughout the lamination process and not be filled with glue, which normally is the case when gluing the plies together.

1. Method for producing a multi-ply web of flexible material, selected from the group consisting of paper and nonwoven material, by gluing the plies, comprising:
applying glue in a glue pattern to a first web shaped material from a patterned glue transfer roll;
laminating a second web shaped material with the first web shaped material in a press nip between a lamination roll and an impression roll to form a laminated web, wherein after lamination, the laminated web is cut and/or perforated in register with the glue transfer while still residing on said impression roll or directly in connection with said impression roll.

2. Method as claimed in claim 1, wherein
the laminated web is cut and/or perforated so as to divide said laminated web into a plurality of web sections.

3. Method as claimed in claim 1, wherein
the first web shaped material and/or the second web shaped material is printed by a printing roll carrying a colorant, a surfactant, a skin care agent or other functional chemical in a selected pattern, and said printing is performed in register with the glue transfer while the first and/or second web shaped flexible materials are residing on said impression roll.

4. Method as claimed in claim 3, wherein
the laminated web is cut and/or perforated in register with the printing so that the printed pattern is undisrupted by the cuts and/or perforations.

5. Method as claimed in claim 3, wherein
glue is transferred to said first web shaped material in a pattern corresponding to the contours of an object, and that after lamination with said second web shaped material the laminated web is cut or perforated adjacent or immediately outside said glue pattern, so as to form objects of laminated web of a desired shape.

6. Method as claimed in claim 5, wherein
the glue pattern does not extend around the entire circumference of the object, but leaves at least one opening through which the interior space between the first and second web shaped materials is accessible.

7. Method as claimed in claim 6, wherein
said object is free from glue sites inside said glue pattern located along the contours of the object.

8. Method as claimed in claim 6, wherein
said object is a pouch, a mitten or a glove.

9. Method as claimed in claim 1, wherein
said lamination roll has a pattern of protuberances corresponding to said glue pattern, the glue transfer roll and the lamination roll being in register with each other.

10. Method as claimed in claim 1, wherein
the glue is a coloured glue, and said coloured glue pattern will appear as a printed pattern.

11. Method as claimed in claim 2, wherein
the cutting and/or perforation of the laminated web is synchronized with the printing of a printed pattern and/or the application of a coloured glue pattern in such a way that web sections have substantially the same pattern printed on them.

12. Method as claimed in claim 1, wherein
the cutting or perforation is carried out by a device having at certain intervals cutting or perforating members and that the impression roll, or a separate counter roll arranged in direct connection with the impression roll and driven in register therewith, is provided at certain intervals with hardened steel bars or anvil knives cooperating with said cutting or perforating members, and the cutting or perforation device is synchronized with the impression roll or the counter roll so that said cutting or perforating members are brought into contact with the hardened steel bars or anvil knives when they hit the impression roll or the counter roll.

13. Method as claimed in claim 1, wherein
at least one of the web shaped materials before lamination with the opposite web shaped materials is exerted to a three dimensional patterning provided on the ply while wet, during drying of the wet ply and/or in dry state.

14. Method as claimed in claim 1, wherein
at least one web shaped materials is embossed in a selected embossing pattern in register with the lamination and perforation and/or cutting of the web material.

15. Method as claimed in claim 1, wherein
any of said web shaped materials comprises one or more plies of flexible material.

16. Multi-ply web of flexible material, selected from the group consisting of paper and nonwoven, comprising at least one first and one second ply which are interconnected by gluing in a glue pattern, wherein
the web is cut or perforated in a pattern which is in register with the glue pattern.

17. Multi-ply web as claimed in claim 16, wherein
the web is printed with at least one printing pattern comprised of a colorant, a surfactant, a skin care agent or other functional chemical, said printing pattern is in register with the glue pattern and the pattern of cuts or perforations.

18. Multi-ply web as claimed in claim 17, wherein
the glue is coloured and thus appears as a printed pattern which is visible through the multi-ply web.

19. Multi-ply web as claimed claim 17, wherein that the printed pattern and/or coloured glue pattern is undisrupted by the cuts and/or perforations.

20. Multi-ply web as claimed in claim 17, wherein
the cuts or perforations define web sections and the cuts or perforations are synchronized with the printed pattern and/or the coloured glue pattern so that the web sections have substantially the same visible pattern thereon.

21. Multi-ply web as claimed in claim 16, the glue pattern corresponds to the contours of an object and that the cuts or perforations are located adjacent or immediately outside said glue pattern, so as to form objects of laminated web of a desired shape.

22. Multi-ply web as claimed in claim 21, wherein
the glue pattern does not extend around the entire circumference of the object, but leaves at least one opening through which the interior space between the first and second web shaped materials is accessible.

23. Multi-ply web as claimed in claim 22, wherein
said object is free from glue sites inside said glue pattern located along the contours of the object.

24. Method as claimed in claim 21, wherein
said object is a glove or mitten.

25. Multi-ply web as claimed in claim 16, wherein
at least one of the plies has a three-dimensional pattern provided before joining with the opposite ply.

26. Multi-ply web as claimed in claim 16, at least one ply is embossed in a selected embossing pattern which is in register with the glue pattern and any present printed pattern.
